(19) United States
(12) Patent Application Publication
(10) Pub. No.: US 2014/0232813 A1
(43) Pub. Date: Aug. 21, 2014

(54) USING METADATA FOR VIDEO MESSAGE MODIFICATIONS AMONG WIRELESS COMMUNICATION DEVICES

(71) Applicant: Sprint Communications Company L.P., (US)

(72) Inventors: Harry Hong-Lun Lai, Overland Park, KS (US); Robert P. Dill, Overland Park, KS (US); Byron R. Cahoon, Peculiar, MO (US); Stephanie Marie Lashley, Parkville, MO (US); Rudolph H. Ehrenberg, V, Overland Park, KS (US); William Dennis Kelly, Olathe, KS (US); Neeraj S. Hardikar, Olathe, KS (US); Mitchell D. Rice, Kansas City, KS (US)

(73) Assignee: SPRINT COMMUNICATIONS COMPANY L.P., Overland Park, KS (US)

(21) Appl. No.: 13/771,496

(22) Filed: Feb. 20, 2013

(51) Int. Cl. H04N 7/14

(52) U.S. Cl. CPC H04N 7/148
USPC 348/14.02

(57) ABSTRACT

Systems, methods, and software for transferring video messages between wireless communication devices in wireless communication networks are provided herein. In one example, a method of operating a wireless communication device is provided. The method includes wirelessly receiving a video message and responsively displaying the video message. The method also includes receiving first user instructions to modify the video message responsive to displaying the video message and modifying the video message into a modified video message responsive to the first user instructions and creating metadata that describes modifications to the video message to create the modified video message. The method also includes receiving second user instructions to transfer the modified video message and responsively transferring the modified video message with the metadata.

### TECHNICAL FIELD

Aspects of the disclosure are related to the field of communications, and in particular, modifying video messages transferred among wireless communication devices in wireless communication networks.

### TECHNICAL BACKGROUND

Wireless communication systems typically include wireless access systems or radio access networks with equipment such as wireless access nodes and various control/routing nodes, which provide wireless access to communication services for wireless communication devices over wireless links. A typical wireless communication system includes systems to provide wireless access across a geographic region, with wireless coverage areas associated with individual wireless access nodes. The wireless access systems exchange user communications between wireless communication devices and service providers for the communication services. Communication services typically include voice calls, data exchange, web pages, streaming media, text messages, or video messages, among other communication services.

In many wireless communication devices, video messages can be exchanged with other wireless communication devices. These video messages can include multimedia message service (MMS) messages, push-to-talk video, email messages with attachments, or other video messages.

### Overview

Systems, methods, and software for transferring video messages among wireless communication devices in wireless communication networks are provided herein. In one example, a method of operating a wireless communication device is provided. The method includes wirelessly receiving a video message and responsively displaying the video message. The method also includes receiving first user instructions to modify the video message responsive to displaying the video message and modifying the video message into a modified video message responsive to the first user instructions and creating metadata that describes modifications to the video message to create the modified video message. The method also includes receiving second user instructions to transfer the modified video message and responsively transferring the modified video message with the metadata.

In another example, a wireless communication device is provided. The wireless communication device includes a transceiver system configured to wirelessly receive a video message. The wireless communication device also includes a user interface system configured to display the video message responsive to receiving the video message, and receive first user instructions to modify the video message responsive to displaying the video message. The wireless communication device also includes a processing system configured to modify the video message into a modified video message responsive to the first user instructions and create metadata that describes modifications to the video message to create the modified video message. The user interface system is also configured to receive second user instructions to transfer the modified video message. The transceiver system is also configured to transfer the modified video message with the metadata responsive to the second user instructions.

### BRIEF DESCRIPTION OF THE DRAWINGS

Many aspects of the disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views. While several embodiments are described in connection with these drawings, the disclosure is not limited to the embodiments disclosed herein. On the contrary, the intent is to cover all alternatives, modifications, and equivalents.

FIG. 1 is a system diagram illustrating a communication system.

FIG. 2 is a flow diagram illustrating a method of operation of a wireless communication device.

FIG. 3 is a system diagram illustrating a communication system.

FIG. 4 is a flow diagram illustrating a method of operation of a communication system.

FIG. 5 is a block diagram illustrating a wireless communication device.

### DETAILED DESCRIPTION

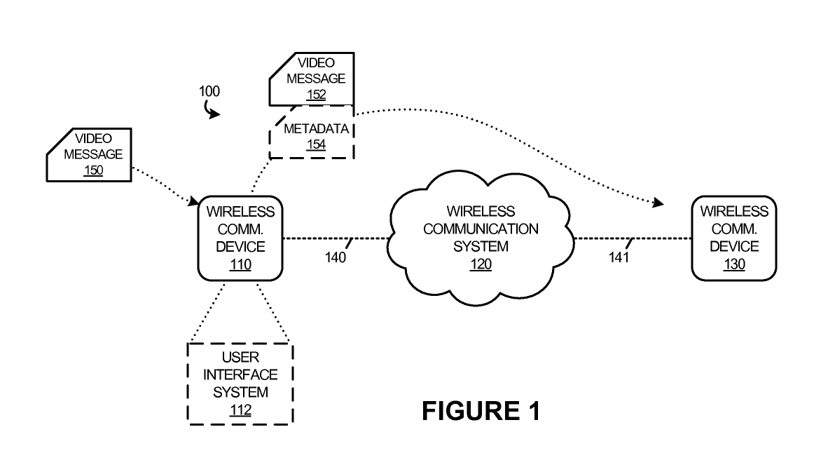

FIG. 1 is a system diagram illustrating communication system 100. Communication system 100 includes wireless communication device 110, wireless communication system 120, wireless communication device 130, and video message 150. Wireless communication device and wireless communication system 120 communicate over wireless link 140. Wireless communication device 130 and wireless communication device 130 communicate over wireless link 141. Wireless communication device 110 includes user interface system 112.

In operation, wireless communication device 110 receives wireless access to communication services from wireless communication system 120. Communication services typically include voice calls, data exchange, web pages, streaming media, text messages, or video messages, among other communication services. Wireless communication device 110 can send and receive video messages, such as video messages 150 and 152 over link 140. Wireless communication device 141 can send and receive video messages over link 141. A wireless access node or base station can provide the wireless access, but is omitted from FIG. 1 for clarity. Although wireless communication devices 110 and 130 are shown communicating directly with wireless communication system 120, other intermediary systems, nodes, and links can be employed.

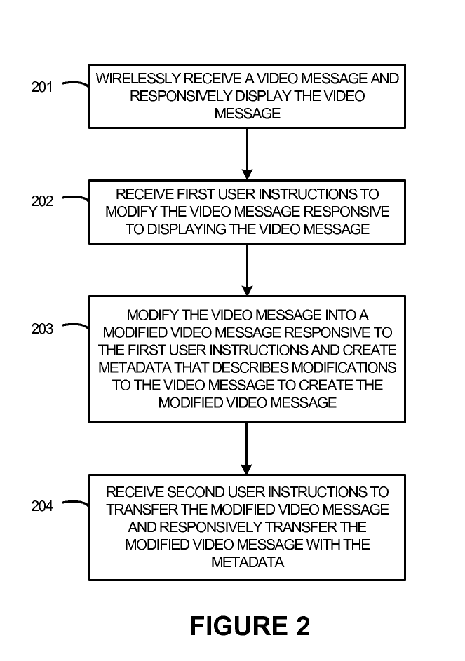

FIG. 2 is a flow diagram illustrating a method of operation of wireless communication device 110. The operations of FIG. 2 are referenced below parenthetically. In FIG. 2, wireless communication device 110 wireless receives (201) video message 150 and responsively displays video message 150. Video message 150 is received over wireless link 140 as transferred by another communication device, which can include wireless communication device 130 or another user device not shown. Video message 150 can include a multimedia message service (MMS) message, push-to-talk video, push-to-video message, email message with a video attachment, or other video messages.

Wireless communication device 110 receives (202) first user instructions to modify video message 150 responsive to displaying video message 150. In this example, the first user instructions can be received by user interface system 112 of wireless communication device 110, such as via a keypad, touchscreen, microphone, video camera, mouse, keyboard, or other user interface elements, including combinations and variations thereof. The first user instructions can include notes, annotations, modifications, alterations, or other changes or comments applied to video message 150. For example, the first user instructions can be received during playback or display of video message 150, such as when a user of wireless communication device 150 makes notes or annotations to video message 150 while watching video message 150.

Wireless communication device 110 modifies (203) video message 150 into modified video message 152 responsive to the first user instructions and creates metadata 154 that describes modifications to video message 150 to create modified video message 154. In some examples, the video data comprising video message 150 is modified into new video data to create modified video message 152. Metadata 154 can describe modifications to the video data of video message 150 which were used to create the new video data of modified video message 152. In other examples, the video data comprising video message 150 is not modified and instead the first user instructions are employed to make one or more new video data which can be inserted, appended, or prepended to video message 150 which, along with the video data of video message 150, creates modified video message 150. Metadata 154 can then describe how and when the one or more new video data is inserted, appended, or prepended to video message 150 to create modified video message 154. Although metadata 154 is shown as a separate item in FIG. 1, metadata 154 can be included in video message 152, such as in a header portion, metadata portion, or other portion of video message 152.

Wireless communication device 110 receives (204) second user instructions to transfer modified video message 152 and responsively transfers modified video message 152. Metadata 154 is also transferred, and as discussed above, can be included in modified video message 152. The second user instructions can include a send instruction which is received through user interface system 112. The second user instructions can include a destination indicator, such as a destination address, destination phone number, destination alias, destination email address, or other destination indicator. The destination indicator can indicate an identifier of wireless communication device 130. Wireless communication device 110 can transfer modified video message 152 over wireless link 140 for delivery to a destination, such as wireless communication device 130. Wireless communication system 120 can receive modified video message 152 and transfer modified video message 152 for delivery to a destination device, such as wireless communication device 130 over wireless link 141.

In a further example, modified video message 152 comprises metadata 154 and video message 150. Wireless communication device 110 modifies video message 150 into modified video message 152 and determines metadata 154 which describes the modifications. However, modified video message 152 is not transferred in this example, and instead metadata 154 and video message 150 are transferred. Once received by another wireless communication device, metadata 154 is used to modify video message 150 into modified video message 152.

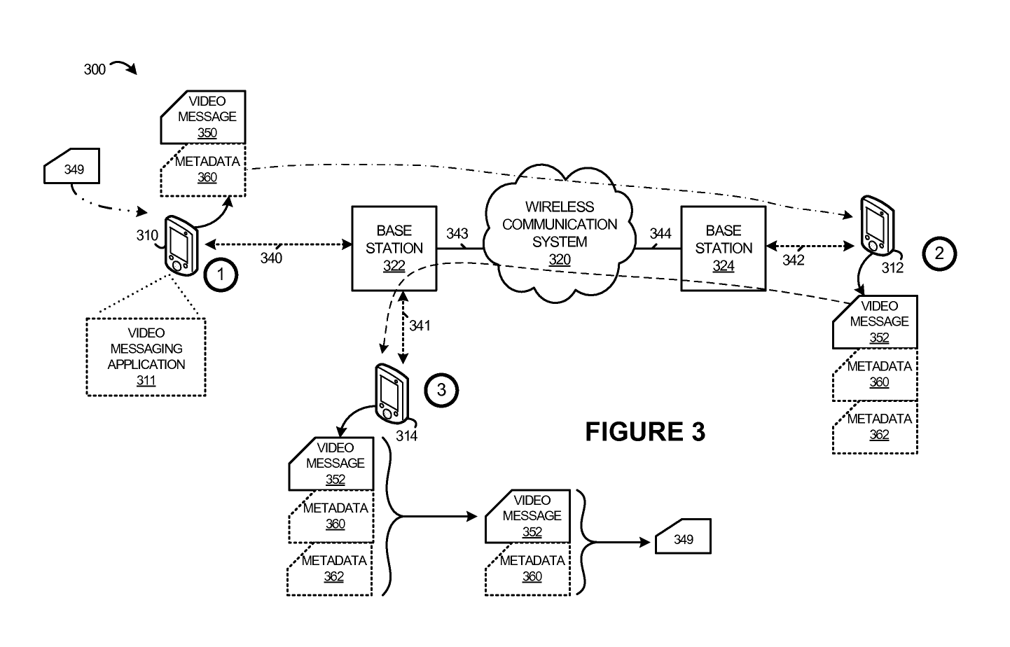

FIG. 3 is a system diagram illustrating communication system 300. Communication system 300 includes smartphones 310, 312, and 314, base stations 322 and 324, and wireless communication system 320. Smartphone 310 and base station 322 communicate over wireless link 340. Smartphone 314 and base station 322 communicate over wireless link 341. Smartphone 312 and base station 324 communicate over wireless link 342. Base station 322 and wireless communication system 320 communicate over backhaul link 343. Base station 324 and wireless communication system 320 communicate over backhaul link 344.

In this example, smartphones 310, 312, and 314 comprise RF communication circuitry and antennas, user interface systems, storage systems, and processing systems. Base stations 322-324 comprise RF communication circuitry and antennas, processing systems, network interfaces, and other equipment, such as indicated for wireless communication system 120 of FIG. 1. Wireless communication system 320 includes routers, switches, and communication interfaces and is a core network of a cellular voice and data communication provider. Wireless communication system 320 can include equipment and systems discussed for wireless communication system 120 of FIG. 1. Wireless links 340-342 can include any wireless communication link discussed for links 140-141 in FIG. 1. Links 343-344 comprise T1 communication links in this example.

In operation, smartphones 310, 312, and 314 can receive video messages transferred by each other or other user devices. Smartphones 310, 312, and 314 can also send video messages for receipt to each other or to other user devices. Although the video messages can include video messages as described above in FIGS. 1 and 2, in this example the video messages comprise push-to-talk videos, which can also describe push-to-video messages. Push-to-talk videos include videos captured or recorded upon pressing of a button, touchscreen function, or voice command by a user, similar to push-to-talk features, except for video. Users of each of smartphones 310, 312, and 314 can instruct the respective smartphones to receive notes or annotations into the video messages from the users, and responsively have the smartphones modify the video messages into modified video messages. The annotations can be received responsive a button press, touchscreen function, or voice command by a user. However, to recreate the original video messages, metadata describing the modifications to create the modified video messages from the original video messages are also created. These modified video messages and associated metadata can be transferred for delivery to other smartphones for viewing by users.

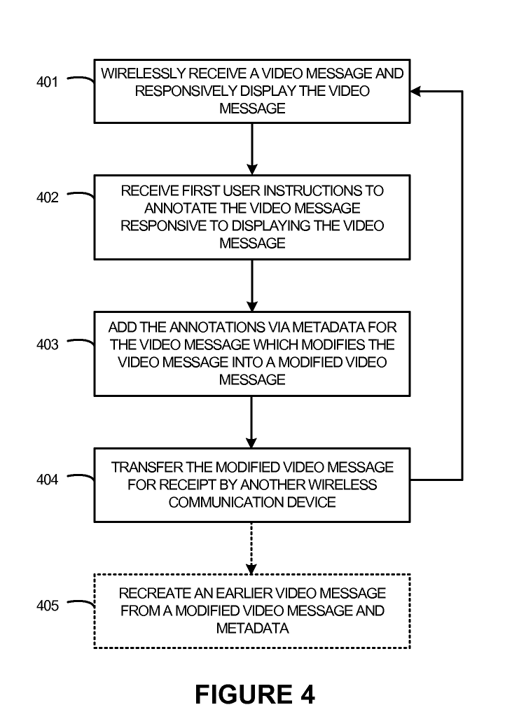

As a further example of the operation of communication system 300, FIG. 4 provided which is a flow diagram illustrating a method of operation of communication system 300. The operations of FIG. 4 are referenced below parenthetically. In FIG. 4, smartphone 310 wireless receives (401) video message 349 and responsively displays video message 349. In this example, smartphone 310 includes video messaging application 311 which can display video message 349 to a user of smartphone 310, such as on an audio/visual display of smartphone 310. Video message 349 can comprise a presentation, movie, video clip, television show, video recording, animation, or other video data, and can also include audio content such as a soundtrack or audio narration. In some examples, video message 349 was captured by a push-to-video application on another device and comprises video/audio created by a user of the other device.

During playback of video message 349, a user of smartphone 310 can instruct smartphone 310 to annotate video message 349 with notes such as video, audio, or graphical comments. These annotations can occur during playback and be intended for insertion in situ with video message 349, such as during a particular time, on a particular slide or frame, or during a particular scene, including combinations and variations thereof. In some examples, the annotations are intended for overlay on video message 349, such as notes or shapes drawn on a touchscreen or with a stylus during playback of video message 349. Thus, smartphone device 310 receives (402) first user instructions to annotate video message 349 responsive to displaying video message 349. In this example, the first user instructions can be received by video messaging application 311 of smartphone 310, such as via a keypad, touchscreen, microphone, video camera, stylus, mouse, keyboard, or other user interface elements, including combinations and variations thereof. The first user instructions can include instructions to apply notes, annotations, modifications, alterations, or other changes or comments applied to video message 349.

Smartphone device 310 adds (403) the annotations via metadata 360 for video message 349 which modifies video message 349 into first modified video message 350. Metadata 360 can describe modifications to video message 349 which establish first modified video message 350. In this example, the video data comprising video message 349 is not modified and instead the first user instructions are employed to make one or more first new video data which can be inserted, appended, or prepended to video message 349 which, along with the information described or contained in metadata 360, creates first modified video message 350. Thus, first modified video message 350 includes video message 349 and the first new video data. Metadata 360 can then describe how and when the one or more first new video data is inserted, appended, or prepended to video message 349 to create first modified video message 350. Metadata 360 can comprise timestamps, time indicators, frame indicators, motion data, animations, slide indicators, durations, or other information which can describe the annotations which are used to modify the original video data of video message 349. For example, if the first new video data comprises a video clip, audio clip, or on-screen annotations of notes from a user of smartphone 310, then metadata 360 can describe an insertion time or frame number to begin insertion of the first new video data, along with other information such as a stop time, stop frame number, or duration, and the like. Although metadata 360 is shown as a separate item in FIG. 3, metadata 360 can be included in first modified video message 350, such as in a header portion, footer portion, metadata portion, or other portion of first modified video message 350.

In further examples, the original video data comprising first modified video message 350 is modified into the first new video data to create first modified video message 350, such as in creating a new video data file comprising the original video data of video message 349 and the first new video data of first modified video message 350. Metadata 360 can describe operations or information used to add the first new video data to the original video data when creating first modified video message 350 to be used to recreate video message 349 or extract the original video data of video message 349.

Smartphone 310 transfers (404) first modified video message 350 for receipt by another wireless communication device. In this example, smartphone 310 transfers first modified video message 350 over wireless link 340 for receipt by smartphone 312 over wireless link 342, as indicated by the dot-dash line in FIG. 3. Wireless communication system 320 transports first modified video message 350 via at least base stations 322 and 324 and links 343-344. User instructions can be received by smartphone 310, such as via video messaging application 311, to indicate first modified video message 350 is to be transferred. Metadata 360 is also transferred, and as discussed above, can be included in first modified video message 350. The user instructions can include a destination indicator, such as a destination address, destination phone number, destination alias, destination email address, or other destination indicator. The destination indicator can indicate smartphone 312.

The process described in operations 401-404 can be similarly applied to smartphone 312. Smartphone 312 receives (401) first modified video message 350 and metadata 360 over wireless link 342. A user of smartphone 312 can display first modified video message 350 on a user interface system of smartphone 312. During display of first modified video message 350, a user of smartphone 312 can add audio, video, image, or animated annotations, comments, or notes to first modified video message 350 in a similar manner as described above for operation 402. These annotations can be used to create second new video data which can be incorporated into second modified video message 352 as in operation 403 above. Metadata 362 can describe the operations or information which is used to create second modified video message 352 from first modified video message 350. In other examples, metadata 360 and 362 are composite metadata describing the operations or information used to create both first modified video message 350 and second modified video message 352. The original video data of video message 349 and the first new video data of video message 350 can be included with the second new video data of video message 352. Smartphone 312 can then transfer second modified video message 352, along with any associated metadata, for delivery to another wireless communication device, such as smartphone 314. Second modified video message 352 is thus transferred (404) over wireless link 342, base station 342, link 344, wireless communication system 320, link 343, and wireless link 341.

The process described in operations 401-404 can also be similarly applied to smartphone 314 as done for smartphone 312, and a further discussion of operations 401-404 is omitted for clarity. Alternatively, the process described in operation 405 can be performed. Smartphone 314 can receive second modified video message 352 and metadata 360-362 over wireless link 341. A user of smartphone 314 can display second modified video message 352 on a user interface system of smartphone 314. It should be understood that operation 405 can be performed by any of smartphones 310-314, similar to what is described below for smartphone 314.

In operation 405, smartphone 314 recreates an earlier video message from a modified video message and metadata associated with that modified video message. In a first example, smartphone 314 processes video message 352 and one or more of metadata 360-362 to recreate video message 350. In a second example, smartphone 314 processes video message 352 and one or more of metadata 360-362 to recreate video message 349. In a third example, smartphone 314 processes a recreated video message 350 and one or more of metadata 360-362 to recreate video message 349.

The various metadata described herein include descriptions of operations or information which can be used to recreate or extract earlier video messages which have been annotated or changed into modified video messages. For example, smartphone 314 can process ones of metadata 360-362 to identify changes to first modified video message 350 that were used to create second modified video message 352. These changes can be un-done, reversed, extracted, or otherwise removed based on the associated metadata to obtain first modified video message 350. Likewise, smartphone 314 can process ones of metadata 360-362 to identify changes to video message 349 that were used to create first modified video message 350. These changes can be un-done, reversed, extracted, or otherwise removed based on the associated metadata to obtain video message 349. In examples where video data is appended to an original video message to create a modified video message, this appended video data can be extracted from the modified video message to recreate the original video message. As discussed above, metadata can describe an insertion time or frame number to begin insertion of new video data, along with other information such as a stop time, stop frame number, or duration, and the like. This metadata can be processed to reverse the insertion process of the new video data and thus recreate the original video data.

In a further example, first modified video message 350 comprises metadata 360 and video message 349. Smartphone 310 modifies video message 349 into first modified video message 350 and determines metadata 360 which describes the modifications. However, first modified video message 350 is not transferred in this example, and instead metadata 360 and video message 349 are transferred. Once received by another smartphone, metadata 360 is used to modify video message 349 into first modified video message 350.

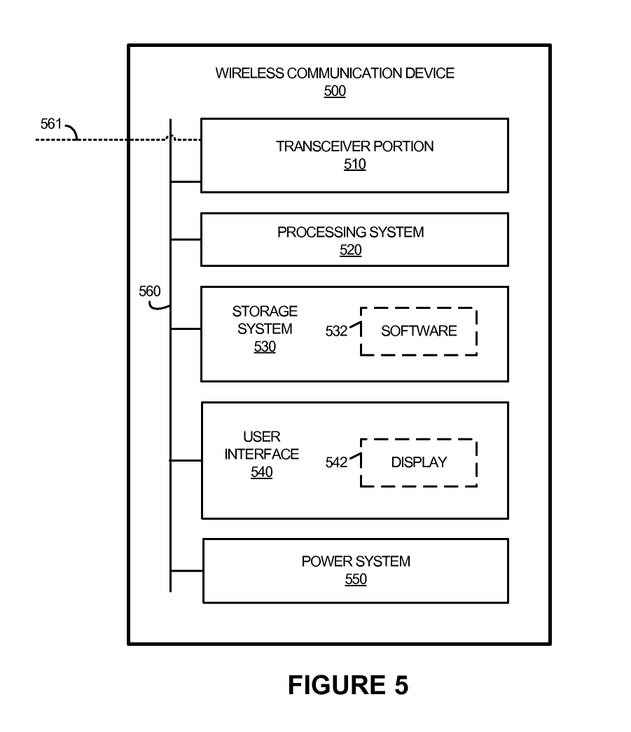

FIG. 5 is a block diagram illustrating wireless communication device 500, as an example of wireless communication devices 110 and 130 found in FIG. 1 or smartphone devices 310, 312, and 314 found in FIG. 3, although wireless communication devices 110 and 130 or smartphone devices 310, 312, and 314 could use other configurations. Wireless communication device 500 includes transceiver system 510, processing system 520, storage system 530, user interface system 540, and power system 550. Transceiver system 510, processing system 520, storage system 530, user interface system 540, and power system 550 are shown to communicate over a common bus 560 for illustrative purposes. It should be understood that discrete links could be employed, such as data links, power links, RF links, or other links. Wireless communication device 500 can be distributed or consolidated among equipment or circuitry that together forms the elements of wireless communication device 500. Wireless communication device 500 can optionally include additional devices, features, or functionality not discussed here for purposes of brevity.

Transceiver system 510 comprises one or more antenna elements and communication interface circuitry for communicating with wireless access nodes of a wireless communication network, such as with base stations of a cellular voice and data network. Transceiver system 510 could include transceiver equipment and antenna elements for wirelessly exchanging user communications and overhead communications over the associated wireless link 561, among further wireless links. Transceiver system 510 also receives command and control information and instructions from processing system 520 or user interface system 540 for controlling the operations of wireless communications over wireless link 561. Wireless link 561 could use various protocols or communication formats as described herein for wireless links 140, 141, or 340-342, including combinations, variations, or improvements thereof.

Processing system 520 can comprise one or more microprocessors and other circuitry that retrieves and executes software 532 from storage system 530, such as video messaging application 311 of FIG. 3. Processing system 520 can be implemented within a single processing device but can also be distributed across multiple processing devices or sub-systems that cooperate in executing program instructions. Examples of processing system 520 include general purpose central processing units, application specific processors, and logic devices, as well as any other type of processing device, combinations, or variations thereof.

Storage system 530 can comprise any computer readable storage media readable by processing system 520 and capable of storing software 532, such as video messaging application 311 of FIG. 3. Storage system 530 can include volatile and nonvolatile, removable and non-removable media implemented in any method or technology for storage of information, such as computer readable instructions, data structures, program modules, or other data. In addition to storage media, in some implementations storage system 530 can also include communication media over which software 532 can be communicated. Storage system 530 can be implemented as a single storage device but can also be implemented across multiple storage devices or sub-systems co-located or distributed relative to each other. Storage system 530 can comprise additional elements, such as a controller, capable of communicating with processing system 520. Examples of storage media include random access memory, read only memory, magnetic disks, optical disks, flash memory, virtual memory and non-virtual memory, magnetic cassettes, magnetic tape, magnetic disk storage or other magnetic storage devices, or any other medium which can be used to store the desired information and that can be accessed by an instruction execution system, as well as any combination or variation thereof, or any other type of storage media. In no case is the storage media a propagated signal.

Software 532 can be implemented in program instructions and among other functions can, when executed by wireless communication device 500 in general or processing system 520 in particular, direct wireless communication device 500 or processing system 520 to communicate with wireless communication systems over wireless links, receive video messages, receive user instructions to modify video messages, modify video messages, and recreate video messages, among other operations. Software 532 can include additional processes, programs, or components, such as operating system software, database software, or application software. Software 532 can also comprise firmware or some other form of machine-readable processing instructions executable by processing system 520.

In at least one implementation, the program instructions can include first program instructions that direct processing system 520 to communicate with wireless communication systems over wireless links, receive video messages, receive user instructions to modify video messages, receive user instructions to transfer video messages, modify video messages, and recreate video messages.

In general, software 532 can, when loaded into processing system 520 and executed, transform processing system 520 overall from a general-purpose computing system into a special-purpose computing system customized to communicate with wireless communication systems over wireless links, receive video messages, receive user instructions to modify video messages, receive user instructions to transfer video messages, modify video messages, and recreate video messages, among other operations. Encoding software 532 on storage system 530 can transform the physical structure of storage system 530. The specific transformation of the physical structure can depend on various factors in different implementations of this description. Examples of such factors can include, but are not limited to the technology used to implement the storage media of storage system 530 and whether the computer-storage media are characterized as primary or secondary storage. For example, if the computer-storage media are implemented as semiconductor-based memory, software 532 can transform the physical state of the semiconductor memory when the program is encoded therein. For example, software 532 can transform the state of transistors, capacitors, or other discrete circuit elements constituting the semiconductor memory. A similar transformation can occur with respect to magnetic or optical media. Other transformations of physical media are possible without departing from the scope of the present description, with the foregoing examples provided only to facilitate this discussion.

User interface system 540 includes equipment and circuitry for receiving user input and control, such as for engaging in voice calls or data sessions, and receiving user instructions for video messages, among other operations. Examples of the equipment and circuitry for receiving user input and control include push buttons, touch screens, selection knobs, dials, switches, actuators, keys, keyboards, pointer devices, microphones, transducers, potentiometers, non-contact sensing circuitry, accelerometers, or other human-interface equipment. User interface system 540 also includes equipment to communicate information to a user of wireless communication device 500. Examples of the equipment to communicate information to the user could include displays, indicator lights, lamps, light-emitting diodes, haptic feedback devices, audible signal transducers, speakers, buzzers, alarms, vibration devices, or other indicator equipment, including combinations thereof. User interface system 540 can describe elements of user interface system 112 of FIG. 1 or video messaging application 311 of FIG. 3.

Power system 550 includes circuitry and a power source to provide power to the elements of wireless communication device 500. The power source could include a battery, solar cell, flywheel, capacitor, thermoelectric generator, chemical power source, dynamo, or other power source. In some examples, power system 550 receives power from an external source, such as a wall outlet or power adapter. Power system 550 also includes circuitry to condition, monitor, and distribute electrical power to the elements of wireless communication device 500.

Bus 560 comprises a physical, logical, or virtual communication link, capable of communicating data, control signals, and communications, along with other information. In this example, bus 560 also includes RF and power distribution elements, such as wires, circuit board traces, or other elements. In some examples, portions of bus 560 are encapsulated within the elements of transceiver system 510, processing system 520, storage system 530, user interface system 540, or power system 550, and can be a software or logical link. In other examples, bus 560 uses various communication media, such as air, space, metal, optical fiber, or some other signal propagation path, including combinations thereof. Bus 560 could be a direct link or might include various equipment, intermediate components, systems, and networks.

Referring back to FIG. 1, wireless communication devices 110 and 130 each can comprise one or more antennas, transceiver circuitry elements, and communication elements. The transceiver circuitry typically includes amplifiers, filters, modulators, and signal processing circuitry. Wireless communication devices 110 and 130 can also each include user interface systems, memory devices, non-transitory computer-readable storage mediums, software, processing circuitry, or some other communication components. Wireless communication devices 110 and 130 can each be a user device, subscriber equipment, customer equipment, access terminal, smartphone, telephone, mobile wireless telephone, personal digital assistant (PDA), computer, e-book, mobile Internet appliance, wireless network interface card, media player, game console, or some other wireless communication apparatus, including combinations thereof.

User interface system 112 of wireless communication device 110 includes equipment and circuitry for receiving user input and control, such as for engaging in voice calls or data sessions, and receiving user instructions for video messages, among other operations. Examples of the equipment and circuitry for receiving user input and control include push buttons, touch screens, stylus interfaces, selection knobs, dials, switches, actuators, keys, keyboards, pointer devices, microphones, transducers, potentiometers, non-contact sensing circuitry, accelerometers, or other human-interface equipment. User interface system 112 also includes equipment to communicate information to a user of wireless communication device 110. Examples of the equipment to communicate information to the user could include displays, indicator lights, lamps, light-emitting diodes, haptic feedback devices, audible signal transducers, speakers, buzzers, alarms, vibration devices, or other indicator equipment, including combinations thereof.

Wireless communication system 120 comprises communication and control systems for providing access to communication services for user devices. Wireless communication system 120 can provide communication services including voice calls, text messages, data access, or other communication services provided over cellular or wireless communication networks. In some examples, wireless communication system 120 includes equipment to provide wireless access to communication services within different coverage areas to wireless communication devices, route communications between content providers and user devices, and facilitate handoffs between equipment of different coverage areas, among other operations. Wireless communication system 120 can also comprise elements such as radio access network (RAN) equipment, E-UTRAN Node B equipment, eNodeB equipment, Evolved Node B equipment, Mobility Management Entity (MME) equipment, Home Subscriber Servers (HSS), Evolved Universal Terrestrial Radio Access (E-UTRA) network equipment, base stations, base transceiver stations (BTS), base station controllers (BSC), mobile switching centers (MSC), home location registers (HLR), radio node controllers (RNC), call processing systems, authentication, authorization and accounting (AAA) equipment, access service network gateways (ASN-GW), packet data switching nodes (PDSN), home agents (HA), mobility access gateways (MAG), Internet access nodes, telephony service nodes, databases, or other communication and control equipment.

Wireless links 140-141 can each use the air or space as the transport media. Wireless links 140-141 each comprise one or more wireless communication links provided over an associated wireless frequency spectrum or wireless frequency band, and can use various protocols. Wireless links 140-141 can each comprise a wireless link such as Code Division Multiple Access (CDMA), Evolution-Data Optimized (EVDO), single-carrier radio transmission technology link (1×RTT), Global System for Mobile Communication (GSM), Universal Mobile Telecommunications System (UMTS), High Speed Packet Access (HSPA), Radio Link Protocol (RLP), 3rd Generation Partnership Project (3GPP) Worldwide Interoperability for Microwave Access (WiMAX), Long Term Evolution (LTE), LTE Advanced, Orthogonal Frequency-Division Multiple Access (OFDMA), Single-carrier frequency-division multiple access (SC-FDMA), Wideband Code Division Multiple Access (W-CDMA), Time Division Synchronous Code Division Multiple Access (TD-SCDMA), IEEE 802.11, Wireless Fidelity (Wi-Fi), or some other cellular or wireless communication format, including combinations, improvements, or variations thereof.

Although one main wireless link for each of wireless links 140-141 is shown in FIG. 1, it should be understood that wireless links 140-141 are merely illustrative to show communication modes or wireless access pathways for wireless communication devices 110 and 130. In other examples, further wireless links can be shown, with portions of the further wireless links shared and used for different communication sessions or different content types, among other configurations. Although wireless link 141 is shown as a wireless link in FIG. 1, a wired link can be employed, or portions of link 141 can include wired portions.

Wireless links 140-141 can each include many different signals sharing the same associated link, as represented by the associated lines in FIG. 1, comprising resource blocks, access channels, paging channels, notification channels, forward links, reverse links, user communications, communication sessions, overhead communications, carrier frequencies, other channels, timeslots, spreading codes, transportation ports, logical transportation links, network sockets, packets, or communication directions.

The included descriptions and figures depict specific embodiments to teach those skilled in the art how to make and use the best mode. For the purpose of teaching inventive principles, some conventional aspects have been simplified or omitted. Those skilled in the art will appreciate variations from these embodiments that fall within the scope of the invention. Those skilled in the art will also appreciate that the features described above can be combined in various ways to form multiple embodiments. As a result, the invention is not limited to the specific embodiments described above, but only by the claims and their equivalents.

What is claimed is:

1. A method of operating a wireless communication device, the method comprising:
wirelessly receiving a video message and responsively displaying the video message;
receiving first user instructions to modify the video message responsive to displaying the video message;
modifying the video message into a modified video message responsive to the first user instructions and creating metadata that describes modifications to the video message to create the modified video message; and
receiving second user instructions to transfer the modified video message and responsively transferring the modified video message with the metadata.

2. The method of claim 1, further comprising:
transferring the modified video message and the metadata for delivery to a second wireless communication device, wherein the metadata provides the second wireless communication device information to recreate the video message from the modified video message.

3. The method of claim 1, wherein the first user instructions are received through one or more a user interface elements of the wireless communication device.

4. The method of claim 1, wherein the first user instructions comprise comments related to the video message and are received from a user of the first wireless communication device.

5. The method of claim 4, wherein the comments comprise audio annotations and wherein modifying the video message into the modified video message comprises inserting the audio annotations into at least an audio portion of the video message.

6. The method of claim 5, wherein the metadata that describes the modifications to the video message comprises at least one start time to begin the audio annotations and at least one stop time to end the audio annotations, wherein the start time and the stop time comprise times relative to a playback time of the video message.

7. The method of claim 5, wherein modifying the video message into the modified video message comprises appending the metadata and the audio annotations to the video message to create the modified video message.

8. The method of claim 4, wherein the comments comprise video annotations and wherein modifying the video message into the modified video message comprises inserting the video annotations into at least a video portion of the video message.

9. The method of claim 8, wherein the metadata that describes the modifications to the video message comprises at least one start time to begin the video annotations and at least one stop time to end the video annotations, wherein the start time and the stop time comprise times relative to a playback time of the video message.

10. The method of claim 8, wherein modifying the video message into the modified video message comprises appending the metadata and the video annotations to the video message to create the modified video message.

11. A wireless communication device, comprising:
a transceiver system configured to wirelessly receive a video message;
a user interface system configured to display the video message responsive to receiving the video message;
the user interface system configured to receive first user instructions to modify the video message responsive to displaying the video message;
a processing system configured to modify the video message into a modified video message responsive to the first user instructions and create metadata that describes modifications to the video message to create the modified video message;
the user interface system configured to receive second user instructions to transfer the modified video message; and
the transceiver system configured to transfer the modified video message with the metadata responsive to the second user instructions.

12. The wireless communication device of claim 11, comprising:
the transceiver system configured to transfer the modified video message and the metadata for delivery to a second wireless communication device, wherein the metadata provides the second wireless communication device information to recreate the video message from the modified video message.

13. The wireless communication device of claim 11, comprising:
the user interface system configured to receive the first user instructions through one or more a user interface elements of the wireless communication device.

14. The wireless communication device of claim 11, wherein the first user instructions comprise comments related to the video message and are received from a user of the first wireless communication device.

15. The wireless communication device of claim 14, wherein the comments comprise audio annotations and comprising:
the processing system configured to insert the audio annotations into at least an audio portion of the video message to create the modified video message.

16. The wireless communication device of claim 15, wherein the metadata that describes the modifications to the video message comprise at least one start time to begin the audio annotations and at least one stop time to end the audio annotations, wherein the start time and the stop time comprise times relative to a playback time of the video message.

17. The wireless communication device of claim 15, comprising:
the processing system configured to append the metadata and the audio annotations to the video message to create the modified video message.

18. The wireless communication device of claim 14, wherein the comments comprise video annotations and comprising:
the processing system configured to insert the video annotations into at least a video portion of the video message to create the modified video message.

19. The wireless communication device of claim 18, wherein the metadata that describes the modifications to the video message comprise at least one start time to begin the video annotations and at least one stop time to end the video annotations, wherein the start time and the stop time comprise times relative to a playback time of the video message.

20. The wireless communication device of claim 18, comprising:
the processing system configured to append the metadata and the video annotations to the video message to create the modified video message.
